(19) United States
(12) Patent Application Publication
(10) Pub. No.: US 2017/0336118 A1
(43) Pub. Date: Nov. 23, 2017

(54) Busniness method of retrofitting refrigeration units for more efficient operation

(71) Applicant: Richard P. Fennelly, Cortlandt Manor, NY (US)

(72) Inventor: Richard P. Fennelly, Cortlandt Manor, NY (US)

(21) Appl. No.: 15/731,262

(22) Filed: May 12, 2017

Related U.S. Application Data
(60) Provisional application No. 62/391,996, filed on May 18, 2016.

(51) Int. Cl. F25B 49/02; B08B 15/00; B08B 5/02; F24F 13/26; B08B 9/023; F25B 39/04; F25B 47/00

(52) U.S. Cl. CPC F25B 49/02; B08B 9/023; B08B 15/00; F25B 39/04; B08B 5/02; F24F 13/26; F25B 47/00; F25B 2500/18; F24F 2221/22

(57) ABSTRACT

The present invention is a method of retrofitting a refrigeration unit, which contains dirty condenser coils, for more efficient operation. The method first comprises cleaning the dirty condenser coils of the refrigeration unit which are contained in an enclosure within such refrigeration unit having an opening. When the coils are in a cleaned condition the enclosure holding those coils is then covered with a non-vented cover that comprises an air-cleaning blower mounted on the outer surface of the cover over an orifice in the cover communicating with the enclosure to supply cleaned air to the enclosure containing the condenser coils.

This application claims the benefit of U.S. Provisional Ser. No. 62/391,996, filed May 18, 2016.

Most existing refrigeration units are in operation with condenser coils that are dirty and are running at reduced efficiency. Such units consume more electric than a unit with clean coils, are prone to more frequent unscheduled service calls when the unit malfunctions because of such dirty coils, have the integrity of the cooled inventory jeopardized because of such malfunction or breakage, and are likely to have a shortened useful life. The present invention is directed to improving this situation in regard to the existing worldwide stock of such units, which is estimated at about 1.5 billion residential and 900 million non-residential units at the present time by certain experts.

The Drawings enclosed herewith will assist in illustrating the present invention wherein:

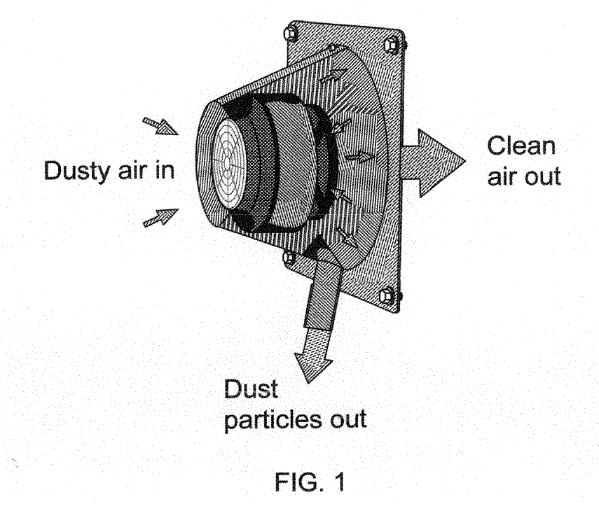

FIG. 1 is a perspective view of a representative air-cleaning blower that can be used in the applicant's improved refrigeration unit;

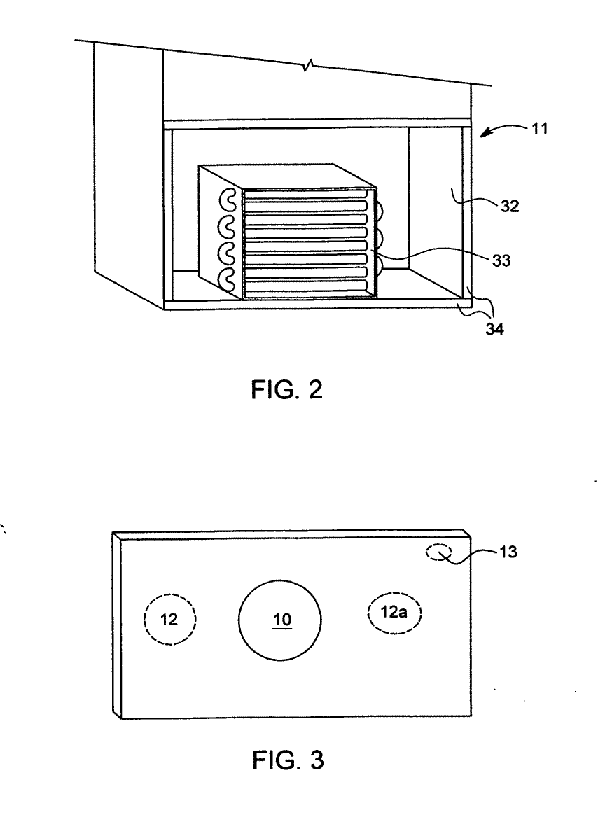

FIG. 2 is a perspective view of a typical commercial refrigeration unit showing the enclosure holding the unit's condenser coils with the cover for the enclosure removed; and

FIG. 3 is a perspective view of applicant's novel cover for the enclosure holding the condenser coils.

The first step in the instant process involves the thorough cleaning of the dirty condenser coils to restore the unit as much as possible to the pristine condition when it was new. While any cleaning method known to the art can be employed, the preferred method is to use a blast of compressed air to remove dust and other debris embedded within the interior of the coil structure. An appropriate dust containment means is preferably employed, such as the COILPOD dust hood, described in U.S. Patent Publication No. 2013/0160800, which is incorporated herein by reference in its entirety.

The next step involves a retrofit of the unit with a novel covering for the opening leading to the enclosure containing the condenser coils during normal operation of the appliance. Heretofore, in conventional appliances, this opening is covered with a vented grille or panel to allow a fan in the condensing unit to pull air into the enclosure so that heat transfer can be promoted from the coils to the atmosphere surrounding the coils. Unfortunately, these vented coverings also allow entry of the dust and other debris that might be in the incoming air stream. Various solutions have been attempted to retard the resulting coil fouling. Condensing units have been modified to include automated brushing means (see U.S. Patent Publication No. 2007/0062211) or the direction of rotation of the fan has been designed to reverse periodically (see U.S. Pat. Nos. 6,792,769 and 7,024,878). Some persons have recommended placing filter media over the panel or grille containing the vents to trap dust and other debris before it enters the enclosure holding the coils.

Our novel solution for the retrofit differs from all of the above and is deemed to be superior. It involves the use of a non-vented covering containing an air cleaning blower on the outside surface thereof as described in co-pending U.S. Ser. No. 15/530,931, filed Mar. 24, 2017, which is incorporated herein by reference. It involves replacing the conventional vented cover now used with a non-vented cover that comprises an air-cleaning blower unit as shown in FIG. 1. This blower is placed over an orifice in the cover that is in communication with the inside of the enclosure holding the condenser coils. The plate shown in FIG. 1 would be appropriately dimensioned to fit over the opening 32, depicted in FIG. 2, holding the condenser coil unit 33 by affixation to surfaces 34 of the refrigeration unit 11.

A preferred conically-shaped air-cleaning blower unit, as depicted in FIG. 1, is described in U.S. Pat. No. 9,259,675, which is incorporated herein by reference, and it is commercially available from Aero Conditioner LLC, Brooklyn, N.Y. 11205 (www.aeroconditioner.com). This apparatus intakes particulate-pervaded air and induces forces to cause the particulates to separate and be expelled from a different outlet than that which is responsible for introduction of the cleansed air stream into the enclosure holing the condenser coils. The apparatus comprises an inlet, housing, impeller, and at least one clean air outlet and one particulate outlet. The use of this air-cleaning blower unit can obviate the need for a fan assembly, as is conventional, in condensing units now in operation or it could be used in conjunction with such fan depending on the blowing power of the selected air-cleaning blower. It is well within the skill in the art to calibrate the needed blowing power of the blower and appropriately connect its electrical wiring to the condensing unit's fan power source(s) within the enclosure. When the refrigeration unit cycles on, the blower, either with or without the conventional condensing fan now commonly used, can cycle on as well to supply a cleaned air flow to promote the needed coil heat transfer.

FIG. 3 shows the novel covering plate 13 of the present invention containing the previously described air-cleaning blower 10, along with optional cleaning ports 12 and 12a which would be covered in normal operation of the refrigeration unit. These ports are analogous to the ports contained in the dust containment bag described in U.S. Patent Publication No. 2013/0160800, which is commercially available under the trademark COILPOD. Such ports allow for coil cleaning, without removal of the cover plate, with a combination of sources of compressed air through port 12, for example, and vacuum through port 12a, for example, once those ports have their covering removed and are thus opened. If desired, an appropriate temperature indicator 13 can also be included, which can signal the presence of dirty coils, either visually or wirelessly. This indicator is connected to the condenser coils as described in U.S. Patent Publication No. 2015/0176932. These coils, when clogged with dirt and debris, will get warmer in general than the baseline condition when they are clean thereby allowing for detection of coil fouling.

In order that the entire unit functions with the lowest electric energy possible, a preferred embodiment utilizes a special class of electric motor for both the fan in the condensing unit, if that is not deactivated, as well as in the air-cleaning blower. Rather than being either an induction (or shaded-pole) motor or the more recently developed electronically commutated motor, the preferred motor is the type of synchronous motor developed by and commercially available from QM Power and designated the Q-Sync Smart Synchronous Motor. This type motor, unlike an electronically commutated motor, does not require continual conversion between AC and DC power throughout its use to operate. The preferred motor's electronics get the motor to its targeted speed and then efficiently shift the motor to AC power supplied directly from the grid. Further details on this type of motor can be found in the following patent documents, which are incorporated herein by reference: U.S. Pat. Nos. 7,898,135; 8,810,084; 9,231,459; and 9,300,237 and U.S. Patent Publication No. 2016/0094113.

An additional optional step, at any point in the process of the present invention, is to utilize in the refrigeration unit a thermal sensor that measures the temperature of an item simulant composition within the refrigeration unit, rather than the air, which can vary dramatically. This is more fully described in U.S. Pat. No. 6,976,368, which is incorporated herein by reference. Commercially available devices of this type that can be used include: the EndoCube or CycleGuard+ products from Universal Master Products or the EnerG2 product from The Madison Energy Group. Once this type of product is installed in a refrigeration unit that unit will have a dramatically reduced level of compressor cycles due to previous false readings of the temperature fluctuations in the air surrounding the item being cooled rather than reading an item simulant composition which approximates the actual temperature of the item being refrigerated.

The Claims that follow define the scope of protection sought.

What is claimed:

1. A method of retrofitting a refrigeration unit, which contains dirty condenser coils, for more efficient operation which comprises: (a) cleaning the dirty condenser coils which are contained in an enclosure, having an opening, within such refrigeration unit; and (b) covering the opening to the enclosure after those coils have been cleaned with a non-vented cover that comprises an air-cleaning blower mounted on the outer surface of the cover over an orifice communicating with the enclosure to supply cleaned air to the enclosure containing the condenser coils.

2. A method as claimed in claim 1 wherein the coils are cleaned using compressed air.

3. A method as claimed in claim 1 wherein the non-vented cover contains ports for coil cleaning with compressed air and vacuum, respectively.

4. A method as claimed in claim 2 wherein the non-vented cover contains ports for coil cleaning with compressed air and vacuum, respectively.

5. A method as claimed in claim 1 which additionally involves placing in the refrigeration unit a thermal sensor that measures the temperature of an item simulant composition within the refrigeration unit.

6. A method as claimed in claim 2 which additionally involves placing in the refrigeration unit a thermal sensor that measures the temperature of an item simulant composition within the refrigeration unit.

7. A method as claimed in claim 3 which additionally involves placing in the refrigeration unit a thermal sensor that measures the temperature of an item simulant composition within the refrigeration unit.

8. A method as claimed in claim 4 which additionally involves placing in the refrigeration unit a thermal sensor that measures the temperature of an item simulant composition within the refrigeration unit.
